(19) United States
(12) Patent Application Publication
(10) Pub. No.: US 2019/0260635 A1
(43) Pub. Date: Aug. 22, 2019

(54) SOFTWARE UPDATE ON A WIRELESS COMMUNICATION DEVICE

(71) Applicant: Hewlett Packard Enterprise Development LP, Houston, TX (US)

(72) Inventors: Praveen Krishnakumar Parangattil, Bangalore Karnataka (IN); Mubeesh Ali Varengal Mohammed, Bangalore Karnataka (IN)

(21) Appl. No.: 15/902,189

(22) Filed: Feb. 22, 2018

(51) Int. Cl. H04L 12/24; H04W 24/02; G06F 8/65; H04L 29/08

(52) U.S. Cl. CPC H04L 41/082; H04W 24/02; H04W 84/02; H04L 67/34; G06F 8/65

(57) ABSTRACT

A method is disclosed of updating software in a first wireless access point, the method comprising sending, by the first access point, an instruction to a client device associated with the first wireless access point to roam to a second wireless access point in a wireless local area network (WLAN), determining that the client device is no longer associated with the first access point, and performing a software update on the first wireless access point.

### BACKGROUND

A communications network can include access points whereby client devices can access the network through the access points. The client devices may then access resources on the network, other client devices and/or other networks such as the Internet.

Occasionally, updated software (e.g. firmware) within an access point may be released, for example by the manufacturer of the access point. Updating the software in an access point may cause downtime of the access point, as functions provided by the access point may become unavailable for a time. For example, client devices may not be able to communicate with the access point and access the network during the software update. As a result, any client devices associate with the access point may become disconnected from the network, and may therefore suffer from reduced functionality.

### BRIEF DESCRIPTION OF DRAWINGS

Examples will now be described, by way of non-limiting example, with reference to the accompanying drawings, in which:

FIG. 1 is a flow chart of an example of a method of updating software in a first wireless access point;

FIG. 2 is a flow chart of an example of a method of updating software in a first wireless access point;

FIG. 3 is a schematic of an example of apparatus for programming a first wireless communication device;

FIG. 4 is a schematic of an example of a network; and

FIG. 5 is a schematic of an example of a machine-readable medium and a processor.

### DETAILED DESCRIPTION

A network may include a plurality of access points. A client device may connect wirelessly to (e.g. become associated with) one of the access points and access the network, or another network or resource connected to the network. For example, the client device may access a network such as the Internet, a resource such as a printer or storage medium, another wireless device, a node in the network or any other accessible device or service. In some examples, the client device may be associated with and communicate with an access point using protocols such as Wi-Fi or an IEEE 802.11 protocol.

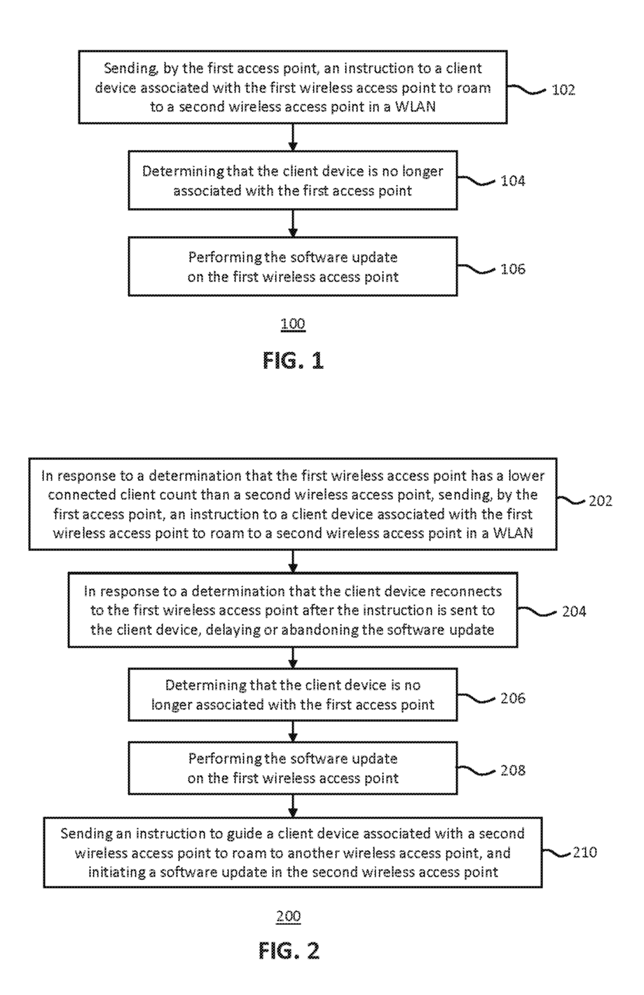

FIG. 1 is a flow chart of an example of a method 100 of updating software in a first wireless access point, such as an access point. The method 100 may be performed by an access point, for example an access point updating its own software, or may be performed by another node, such as for example another access point or a network controller.

Block 102 of the method 100 comprises sending, by the first access point, an instruction to a client device associated with the first wireless access point to roam to a second wireless access point in a wireless local area network (WLAN). For example, the instruction may be sent to a client device, associated with the first access point, to roam to another access point. The instruction may be sent by the first access point, for example, in response to a command from a controller, or in response to the first access point determining that an update of its software is available.

As a result of the instruction, in some examples, the client device may become associated with a different access point within the network (e.g. within the same WLAN as the first access point). The client device may select an access point, for example by highest signal strength or any other suitable criteria. As a result, the client device may suffer from no loss of connectivity, or a very small period of no connectivity while it becomes associated with a different access point.

In some examples, the instruction to the client device, and the client device's subsequent attempt to associate with another wireless access point, may be in accordance with a roaming or handoff protocol or standard such as, for example, a seamless Basic Service Set (BSS) transition conforming to the IEEE 802.11k standard. In other examples, non-standard communications and procedures may be employed.

Block 104 of the method 100 comprises determining that the client device is no longer associated with the first access point. Thus in some examples, the first wireless access point may wait until the client device is no longer associated with it. Next, block 106 of the method 100 comprises performing the software update on the first wireless access point. The software update may cause the first wireless access point to stop providing or offering at least some functionality while the software update is being performed. However, the client device has already roamed to a different access point, and hence there is little or no loss of connectivity or functionality of the client device. Therefore, the software update can be performed in the access point with little or no impact to one or more client devices in the network.

FIG. 2 is a flow chart of an example of a method 200 of updating software in a first wireless access point. The method 200 may be performed by an access point, for example an access point updating its own software, or may be performed by another node, such as for example another access point or a network controller.

Block 202 of the method 200 comprises, in response to a determination that the first wireless access point has a lower connected client count than a second wireless access point, sending, by the first access point, an instruction to a client device associated with the first wireless access point to roam to a second wireless access point in a WLAN. For example, it may be determined that the connected client count, being the number of client devices associated with the first access point, is lower than the connected client count of the second access point.

The access point with the lower connected client count (the first access point) is selected so that to update the software, fewer clients may need to roam to other access points before updating the software than if the second access point is updated. If the second access point is subsequently updated, the number of device migrations from one access point to another may still be lower if the first wireless access point is updated first, thus the impact on the network and/or the client devices may be lower. In some examples, devices migrating from the second wireless access point may prioritize an association with the first access point, if possible, as this access point has already been updated and another migration away from the first access point us unlikely (in the absence of any additional software updates to the first access point).

Block 204 of the method 200 comprises, in response to a determination that the client device reconnects to the first wireless access point (e.g. becomes associated with the first wireless access point again) after the instruction is sent to the client device, delaying or abandoning the software update. In some examples, when the client device associated with the first wireless access point receives the instruction in block 202, the instruction does not identify the other access point to which the client device should connect. Instead, the client device is able to select an access point, based on one or more criteria such as signal strength for example. In some examples, the client device may not attempt to reconnect to the first wireless access point if there is at least one other access point available for connection, but in some cases there may not be another access point available. For example, the client device may not detect any signal (e.g. a beacon) from another access point, or an attempt to associate with another access point was unsuccessful. In this case, the first wireless access point may be the only available access point for the client device. Therefore, the client device may reconnect to the first wireless access point. In some examples, to avoid disruption of service to the client device, the software update for the first wireless access point may be delayed for a period of time, such that it may be attempted at a later time, including for example sending another instruction to the client device to roam to another access point. Alternatively, the software update may be abandoned.

Block 206 of the method 200 comprises determining that the client device is no longer associated with the first access point, and block 208 comprises performing the software update on the first wireless access point. This may be performed if for example the software update was not delayed or abandoned in block 204. Initiating a software update may comprise, for example, if the access point is carrying out the method 200, performing the software update. Alternatively, for example, where the method 200 is carried out by another node such as another access point or a controller, initiating the software update may comprise sending an instruction to the first access point to perform the software update. In some examples, the software update may be available to the first wireless access point, such as for example available from a storage device in the network or from a location on the internet.

Block 210 of the method 200 comprises sending an instruction to guide a client device associated with a second wireless access point to roam to another wireless access point, and initiating a software update in the second wireless access point. The instruction may be sent in some examples to the client device associated with the second wireless access point. The second access point may in some examples not be a neighbour of the first wireless access point. In some examples, the client device connected to the second access point may not roam to the first access point. For example, the client device may be instructed not to roam to the first wireless access point. The client device may be the same client device that was associated with the first wireless access point in block 202, in which case the client device roamed to the second wireless access point. Alternatively, the client device may be a different client device. Upon receipt of the instruction, the client device roams to another wireless access point (which may be the first wireless access point or a different wireless access point), and the software update in the second wireless access point is initiated. In some examples, the client device may reconnect to the second wireless access point (e.g. if there is no other access point available to the client device), and therefore be associated with the second wireless access point. Therefore, the software update in the second wireless access point can be delayed or abandoned.

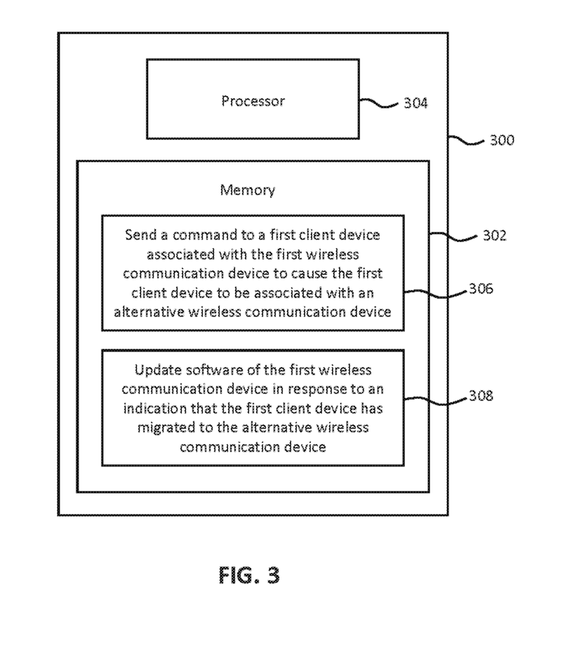

FIG. 3 is a schematic of an example of apparatus 300 for programming a first wireless communication device. In some examples the apparatus 300 may be a wireless communication device such as an access point, or another device such as a network controller or a device programmer. The apparatus 300 comprises a memory 302 and a processor 304. The processor 304 is to execute instructions from the memory 302 to send 306 a command to a first client device associated with the first wireless communication device to cause the first client device to be associated with an alternative wireless communication device, and update 308 software of the first wireless communication device in response to an indication that the first client device has migrated to the alternative wireless communication device. Thus, the first wireless communication device may be programmed without significant disruption or loss of service for the first client device. The command may in some examples be in accordance with a protocol such as 802.11 or 802.11r, for example.

In some examples, the processor 304 is to execute instructions from the memory 302 to send a command to a client device connected to a second wireless communication device to cause the client device to be associated with an alternative wireless communication device in response to completion of updating the software of the first wireless communication device, and to update the software of the first wireless communication device in response to an indication that the client device has roamed to the alternative wireless communication device. The client device may be the first client device or a different client device. Therefore, both the first and second wireless communication devices can be programmed without significant disruption or loss of service for one or more client devices connected to the wireless communication devices (e.g. access points).

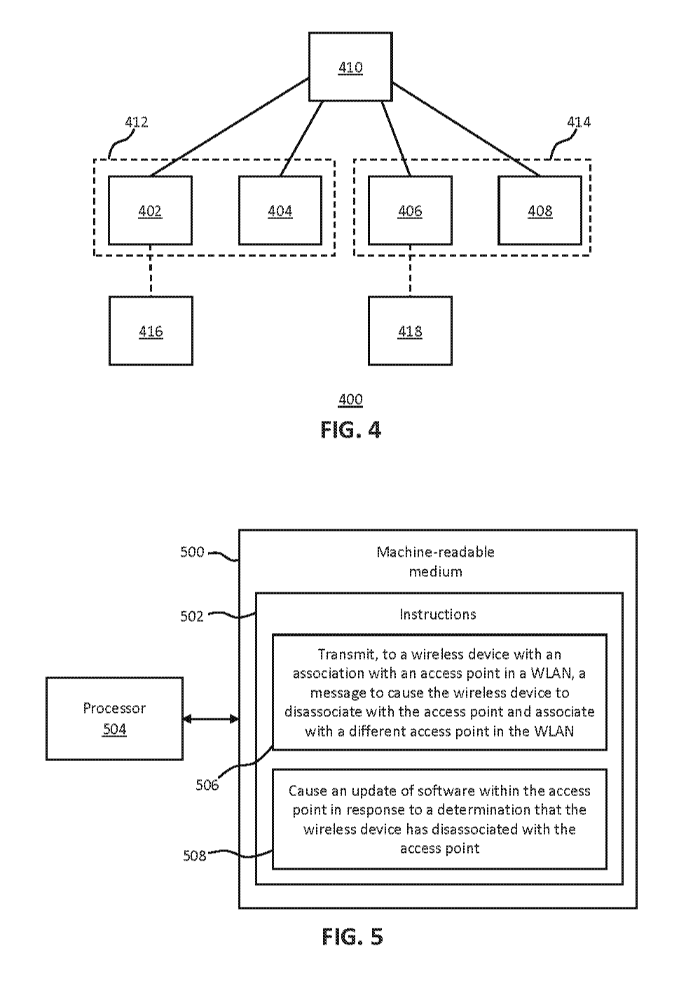

In some examples, the processor 304 is to execute instructions from the memory 302 to group the first wireless communication device and a second wireless communication device into a first group, and to group a third wireless communication device and a fourth wireless communication device into a second group. This is illustrated in FIG. 4, which shows an example of a network 40400 including wireless communication devices (e.g. access points) 40402, 40404, 40406 and 40408 and a controller 410. The apparatus 300 may in some examples comprise or be included in the controller 410, one or more of the wireless communication devices 402, 404, 406 and 408 or another node. The grouping module may group wireless communication devices 402 and 404 into a first group 412, and wireless communication devices 406 and 408 into a second group 414. FIG. 4 also shows, as an illustrative example, a first client device 416 associated with wireless communication device 402, and a second client device 418 associated with wireless communication device 406.

In some examples, each group may include one or more devices, and there may be two or more groups. The devices may in some examples be grouped according to physical location. For example, wireless communication devices 402 and 404 in group 412 may be located close to each other, and wireless communication devices 406 and 408 in group 414 may be located close to each other. Alternatively, in some examples the devices may be grouped according to network location. That is, two wireless communication devices that could detect a strong signal from each other compared to other wireless communication devices may be considered as “close” to each other in the network. Devices that are “close” to each other in a network in this way in some examples may or may not be physically close to each other due to factors affecting the network environment, such as for example physical obstructions, interference, devices being located on different floors of a building, and/or other factors.

Wireless communication devices that are located close to each other (physical or network location) may be referred to as neighbours. Network management software such as, for example, Adaptive Radio Management (ARM) may in some examples be used to determine which wireless communication devices are neighbours, physically and/or in the network.

In some examples, the processor 304 is to execute instructions from the memory 302 to send a command to a second client device 418 connected to the third wireless communication device 406 to cause the second client device 418 to connect to an alternative wireless communication device. In some examples, devices in a group are neighbours, and so in some examples it is probable that the second client device 418 connects to wireless communication device 408 in the same group 414. Similarly, the first client device 416 may connect to the wireless communication device 404 in the same group 412.

In some examples, the processor 304 is to execute instructions from the memory 302 to update software on the third wireless communication device 406 in response to an indication that the second client device 418 has roamed to the alternative wireless communication device (e.g. the wireless communication device 408). Similarly, in some examples, the processor 304 is to execute instructions from the memory 302 to update software on the first wireless communication device 402 in response to an indication that the first client device 416 has roamed to the alternative wireless communication device (e.g. the wireless communication device 404). As a result of grouping the wireless communication devices in this way, and the possibility that any client devices will probably become associated with another wireless communication device in the same group, after the client devices 416 and 418 have moved (e.g. migrated) to another wireless communication device, it is possible or probably that neither of these devices is connected to the wireless communication devices 402 and 406. These devices 402 and 406 may therefore be programmed or the software thereon updated, for example simultaneously, without significant disruption or loss of service to the client devices 416 and 418.

In some examples, the processor 304 is to execute instructions from the memory 302 to refrain from updating the software of the second wireless communication device 404 during updating the software of the first wireless communication device 402, and to refrain from updating the software of the fourth wireless communication device 408 during updating the software of the third wireless communication device 406. Subsequently, in some examples, after programming these devices, the other devices 404 and 408 may be programmed after sending instructions to connected client devices to move them to other wireless communication devices (e.g. wireless communication devices 50402 and 50406). In some examples, therefore, devices in a group can each be updated one at a time, and may be updated simultaneously with devices in other groups, while reducing impact on the network such as for example disruption or loss of service for client devices associated with wireless communication devices in the network.

FIG. 5 is a schematic of an example of a machine-readable medium 500 comprising instructions 502 that, when executed by a processor 504, cause the processor 504 to transmit 506, to a wireless device (e.g. a client device) with an association with an access point in a wireless local area network (WLAN), a message to cause the wireless device to disassociate with the access point and associate with a different access point in the WLAN, and cause the processor 504 to cause 508 an update of software within the access point in response to a determination that the wireless device has disassociated with the access point. For example, where the processor 504 is part of an access point, the instructions may cause the processor 504 to perform a software update in the access point. Alternatively, for example, where the processor 504 is part of another node such as a network controller, the instructions may cause the processor 504 to send an instruction to an access point to perform a software update. Thus, for example, the access point may undergo a software update with little or no impact on the wireless device, such as for example access to a network, functionality or a resource by the wireless device.

In some examples, the machine-readable medium 500 comprises instructions 502 that, when executed by the processor 504, cause the processor 504 to, after causing an update of the software within the first wireless access point, transmit a message to a wireless device associated with a further access point to cause the wireless device to disassociate with the access point and associate with another access point (e.g. in the WLAN), and cause the processor 504 to cause an update of software within the further access point. This may occur after the software update of the access point first updated.

In some examples, the machine-readable medium 500 comprises instructions 502 that, when executed by the processor 504, cause the processor 504 to postpone the update of the software in the access point if the wireless device reconnects to the access point in response to the message. This may occur for example if the wireless device has not detected any other access point that it may associate with, or if any association attempt is unsuccessful. Postponement of the update may avoid any disruption or loss of service for the wireless device. The software update (including sending another message to the wireless device) may in some examples be attempted at a later time, at which time an access point may have become available to the wireless device, or the wireless device may have become associated with an alternative access point for another reason, such as for example the wireless device has moved.

In some examples, the machine-readable medium 500 comprises instructions 502 that, when executed by the processor 504, cause the processor 504 to transmit the message to the wireless device if the access point has fewer wireless devices connected to it than a second access point. As a result, there may in some examples be fewer network interactions or disruption than if the second access point is updated before the first access point. The second access point may be updated for example after the first access point has been updated, for example including sending commands to client devices associated with the second access point to disassociate with the second access point and associate with an alternative access point (which may in some examples include the first access point).

The client devices or wireless devices referred to above that associate with an access point or other wireless device may be any device capable of associating with an access point or wireless device, and may include, for example, a laptop computer, desktop computer, mobile telephone, tablet computer or other computing or data processing device.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfill the functions of several units recited in the claims.

The features of any dependent claim may be combined with the features of any of the independent claims or other dependent claims.

1. A method of updating software in a first wireless access point, the method comprising:
sending, by the first access point, an instruction to a client device associated with the first wireless access point to roam to a second wireless access point in a wireless local area network (WLAN);
determining that the client device is no longer associated with the first access point; and
performing a software update on the first wireless access point.

2. The method of claim 1, comprising, in response to a determination that the client device reconnects to the first wireless access point after the instruction is sent to the client device, delaying or abandoning the software update.

3. The method of claim 1, comprising, in response to a determination that the first wireless access point has a lower connected client count than a second wireless access point, performing the sending the instruction to the client device.

4. The method of claim 3, comprising, after performing the software update in the first wireless access point:
sending an instruction to a client device connected to the second wireless access point to roam to another wireless access point; and
initiating a software update in the second wireless access point.

5. The method of claim 1, wherein sending the instruction to the client device uses a seamless Basic Service Set (BSS) transition conforming to the IEEE 802.11k standard.

6. The method of claim 1, comprising:
sending an instruction to guide a client device associated with a second wireless access point to roam to another wireless access point, wherein the second wireless access point is not a neighbour of the first wireless access point; and
initiating a software update in the second wireless access point.

7. The method of claim 6, comprising, in response to a determination that a third wireless access point is a neighbour of the first wireless access point, not initiating a software update in the third wireless access point.

8. Apparatus for programming a first wireless communication device, the apparatus comprising:
a memory;
a processor to execute instructions from the memory to:
send a command to a first client device associated with the first wireless communication device to cause the first client device to be associated with an alternative wireless communication device; and
update software of the first wireless communication device in response to an indication that the first client device has migrated to the alternative wireless communication device.

9. The apparatus of claim 8, wherein the processor is to execute instructions from the memory to:
group the first wireless communication device and a second wireless communication device into a first group, and to group a third wireless communication device and a fourth wireless communication device into a second group;
wherein the migration module is to send a command to a second client device connected to the third wireless communication device to cause the second client device to connect to an alternative wireless communication device;
wherein the programming module is to program the third wireless communication device in response to an indication that the second client device has roamed to the alternative wireless communication device; and
wherein the first communication device is a neighbour of the second communication device, and the third communication device is a neighbour of the fourth communication device.

10. The apparatus of claim 9, wherein the programming module is to refrain from updating the software of the second wireless communication device during updating the software of the first wireless communication device, and to refrain from updating the software of the fourth wireless communication device during updating the software of the third wireless communication device.

11. The apparatus of claim 8, wherein the processor is to execute instructions from the memory to:
send a command to a client device associated with a second wireless communication device to cause the client device to be associated with an alternative wireless communication device in response to completion of updating the software of the first wireless communication device; and
to update the software of the first wireless communication device in response to an indication that the client device has roamed to the alternative wireless communication device.

12. A machine-readable medium comprising instructions that, when executed by a processor, cause the processor to:
transmit, to a wireless device with an association with an access point in a wireless local area network (WLAN), a message to cause the wireless device to disassociate with the access point and associate with a different access point in the WLAN; and
cause an update of software within the access point in response to a determination that the wireless device has disassociated with the access point.

13. The machine-readable medium of claim 12, comprising instructions that, when executed by the processor, cause the processor to:
after causing an update of the software within the first wireless access point, transmit a message to a wireless device associated with a further access point to cause the wireless device to disassociate with the access point and associate with another access point; and
cause an update of software within the further access point.

14. The machine-readable medium of claim 12, comprising instructions that, when executed by the processor, cause the processor to postpone the update of the software in the access print if the wireless device reconnects to the access point in response to the message.

15. The machine-readable medium of claim 12, comprising instructions that, when executed by the processor, cause the processor to transmit the message to the wireless device if the access point has fewer wireless devices connected to it than a second access point.
